(19) United States
(12) Patent Application Publication
(10) Pub. No.: US 2004/0243425 A1
(43) Pub. Date: Dec. 2, 2004

(54) Method for delivering a product to a consumer and identifying means associated therewith

(76) Inventors: Rolf-Gunter Genzel, Leipzig (DE); Wilke Lubben, Kirchehrenbach (DE)

Correspondence Address: HARNESS, DICKEY & PIERCE, P.L.C., P.O.BOX 8910, RESTON, VA, 20195, US

(21) Appl. No.: 10/487,344

(22) PCT Filed: Aug. 19, 2002
(86) PCT No.: PCT/EP02/09252

(30) Foreign Application Priority Data
Aug. 21, 2001 (EP) 01250299.3

(51) Int. Cl. G06F 17/60

(52) U.S. Cl. 705/1; 705/404

(57) ABSTRACT

A method is for delivering a product to a consumer in the field of electrotechnical switchboards and cabinet systems. A technology commissioner acts as a franchiser and a full range of documentation for producing a product is made available for a franchise recipient. The franchisee commissioner also prepares an identification device which contains at least one data carrier for identifying the franchise commissioner, which the franchise recipient attaches to the product before delivery to the consumer.

This application is the national phase under 35 U.S.C. § 371 of PCT International Application No. PCT/EP02/09252 which has an International filing date of Aug. 19, 2002, which designated the United States of America and which claims priority on German Patent Application number EP 01250299.3 filed Aug. 21, 2001, the entire contents of which are hereby incorporated herein by reference.

### FIELD OF THE INVENTION

The invention generally relates to a method for delivering a product to a consumer in the field of electrotechnical switchgear and cabinet systems. Preferably, it relates to a method in which a technology commissioner prepares the technical specification of the product and entrusts it to a technology recipient within the framework of a contractual agreement for commercial exploitation for the purpose of delivery to the consumer.

### BACKGROUND OF THE INVENTION

A method is customarily used when a company acting as a technology commissioner would like products from its own development not only to be produced by itself and sold to consumers on its own account. Then, for example, the company itself delivers to consumers in a specific regional market from a production facility that has been especially adapted and is commercially favorable. Other regional markets are served by one or more technology recipients, which act independently as licensees within the framework of contractual agreements with the technology commissioner. For the consumers, this generally results in shorter delivery distances and delivery times.

Details of this known method are illustrated in FIG. 1. The block designated by 1 in this case includes the activities of the technology commissioner. The latter runs an organization required for the development of a product and, in step 1.1, initially devises a product idea for a switchgear unit or a cabinet system of an innovative specification. In keeping with the complex structure a of product of this type, this is followed in steps 1.2, 1.3, 1.4, and possibly further steps, by the development of the various required components such as a framework, enclosing parts, a busbar, assembly or modular installation systems and equipment.

Once this activity has been successfully completed, specimens of the product can be produced and tested in step 1.5. If the specimens meet expectations, the product is subjected to a type test in step 1.6, as the result of which it is established that the properties of the product conform to specific relevant standards and regulations.

To simplify the representation, FIG. 1 omits to show loops indicating possibly required repetitions. In particular, a renewed development may be required if it is only evident from the finished product specimen that there is a need for improvement or modification. It may likewise be required for type tests to be carried out a number of times if the product is to be launched in a number of markets, in which different regulations apply.

The method steps described above are taken as precautions accompanying areas of activity for the protection of industrial property, in order to ensure the independence of the new development from protective rights of others and at the same time to acquire protective rights of one's own. Apart from the purely technical protective rights, protective trademark and design rights may also arise, and may be the basis for a trademark license. All or some of these protective rights represent the basis of contractual agreements with technology recipients, which are indicated in FIG. 1 as blocks 2 and 3.

For simplification, only some of the method steps arising for the technology recipient acting as a licensee are shown in block 2 of FIG. 1. These include in particular the use and exploitation of the licensed protective rights, in step 2.1, and the generally required development of unlicensed auxiliaries and components, in step 2.2. Although the product created in this procedure may have significant properties of the product developed by the licensor (block 1 in FIG. 1), they generally do not correspond to the latter to such an extent that the type testing carried out by the licensor also applies to the licensee's product. In particular, the licensee is unrestricted in its production processes, the procurement of semifinished products, raw materials, etc. Therefore, independent type testing is provided in step 2.3. Further licensees (block 32 in FIG. 1) are subject to similar conditions.

### SUMMARY OF THE INVENTION

An embodiment of the invention is based on an object of providing a different method for delivering products of the stated type to consumers in which the effort involved in delivering products of the stated type way to consumers is significantly reduced and product security increased.

According to an embodiment of the invention, for this purpose the method has the following steps or features:

the technology commissioner acts as a franchisor by providing the specification and further auxiliaries required for production of the product in a type-tested configuration, in the form of technical instructions and information, as well as the rights to use a trademark of the technology commissioner,

the technology recipient acts as a franchisee by exploiting the specification, the auxiliaries and the rights of use,

the franchisor provides an identifying means, which bears a data carrier for the identification of the franchisor that can be read by means of an electronic reader,

the franchisee attaches the identifying means to the product after production of the same and delivers the product to the consumer.

The use of a franchise system in connection with electrotechnical products of the stated type indicates a significant improvement in the delivery to consumers in an arbitrary region. The improvement is based on the one hand on the ability of a franchisee to deliver being achieved much more quickly than in the case of the previously customary licensing, since it is of the very nature of franchise systems that the franchisee receives support from the franchisor that goes significantly beyond a simple license. In particular, the licensee is not only provided with all the required technical documentation for producing the products, but also, as and when required, with significant components, tools, devices and raw materials or semifinished products.

As a result, the licensee is put in a position to deliver the product in a type-tested configuration without having to concern itself with the often laborious and elaborate tests and certification procedures to demonstrate that appropriate requirements are satisfied. Furthermore, a trademark license is always included, allowing the franchisee to act accordingly in relation to the consumers.

To be emphasized as a further valuable property of the method according to the invention is that the identifying device allows the identity of all products produced and delivered within the framework of the franchise system to be verified at any time. As a result, unauthorized reproduction of the products can be established.

This is an aspect which goes far beyond commercial considerations and covers in particular questions of product responsibility and technical security. This is so because the fact that the franchisor has an effective means for establishing the unequivocal association of a product with a franchise agreement concluded by it enables it to identify products which have been reproduced without authorization and are possibly technically unreliable or defective (“fake products”) and successfully defend itself against claims for compensation.

Within the scope of an embodiment of the invention, the data carrier may take the form of a barcode, with a barcode reader which is portable, can be operated independently of the power supply system and has a display device of its own being provided for registering the data content of the barcode. A barcode obviously represents an inexpensive identifying device. By providing it at a suitable point of the product, it can be ensured that unallowed duplication is largely ruled out.

Enhanced security against misuse can be achieved by the identifying device including a data carrier that can be electronically evaluated for storing the set of data. This has the advantage that a much greater set of data can be defined than a barcode is able to reproduce. Better protection of the data can also be achieved by accommodating the data carrier in the identifying device.

Suitable for the purposes of an embodiment of the invention as highly reliable data carriers which can be used as active (readable and writable) electronic storage means with virtually unassailable forgery-proof security are in particular the integrated memory chips of bank or insurance cards and transponder units. All the data carriers just mentioned can interact with suitable portable readers which have a display device of their own and consequently permit direct evaluation of the set of data. Transponder units have in this case the advantage that data exchange can be carried out contactlessly and from a certain distance.

It may be desired to incorporate in the identification of a product individual features of the latter, such as an order date, circuit diagram, device provided or similar information. For this purpose, it may be provided within the scope of an embodiment of the invention that, before delivering a product to a consumer, the franchisee transmits to the franchisor data of the product specific to said consumer's order, the franchisor prepares an identifying device containing the specific data and transfers it to the franchisee, and the latter attaches the identifying means to the product before it is delivered. If this procedure is followed, it can be established at any time whether the product corresponds to the original specification or has been changed.

Products of the type considered in the present case offer numerous possibilities for attaching the identifying device on account of their spatial extent. Rapid evaluation can be facilitated by the identifying means being attached to the front side of a switch cabinet or a switchgear unit. If, on the other hand, there is reason to consider protection of the identifying device against soiling or damage, the identifying device can also be fixed inside a switch cabinet or a switchgear unit at a point provided for this purpose. In any event, it is recommendable to fix the identifying means in such a way that it cannot be detached, or can only be detached in such a way that damage or destruction ensues.

On the basis of the trademark license associated with the franchise system, the product is generally provided with an externally visible logo or the like of the technology commissioner or franchisor. Within the scope of an embodiment of the invention, the identifying device may for this purpose be formed as a designation plate provided with a logo designating the franchiser and having the data carrier. In this case, the data carrier may be embedded in the material of the designation plate, it being possible for the data carrier to be enclosed by the material of the designation plate and invisible.

### BRIEF DESCRIPTION OF THE DRAWINGS

Further advantages, features and details of the invention will become evident from the description of illustrated embodiments given hereinbelow and the accompanying drawings, which are given by way of illustration only and thus are not limitative of the present invention, wherein:

FIG. 1 illustrates details of a known method.

FIG. 2 shows in a representation corresponding to FIG. 1 delivery to a consumer by the method according to an embodiment of the invention.

Shown in FIG. 3 are a barcode and an associated reader as a device for identifying a product and for checking this identification.

FIG. 4 shows as a further example of an identifying device, including a chip card or smart card with an associated reader.

In FIG. 5, a combined designation plate and identifying device with reader are represented.

FIG. 6 shows the combined designation plate according to FIG. 5 in profile or in a plan view, in order to illustrate the embedding of the identifying device and also an adhesive layer.

In FIG. 7, a switch cabinet with an externally attached identifying device is shown simplified in a front view.

FIG. 8 shows a switch cabinet similar to FIG. 7 with an identifying device attached to the inner side of the door.

As a further example, FIG. 9 shows a three-section switchgear unit with an identifying means which can be registered from outside.

### DETAILED DESCRIPTION OF THE PREFERRED EMBODIMENTS

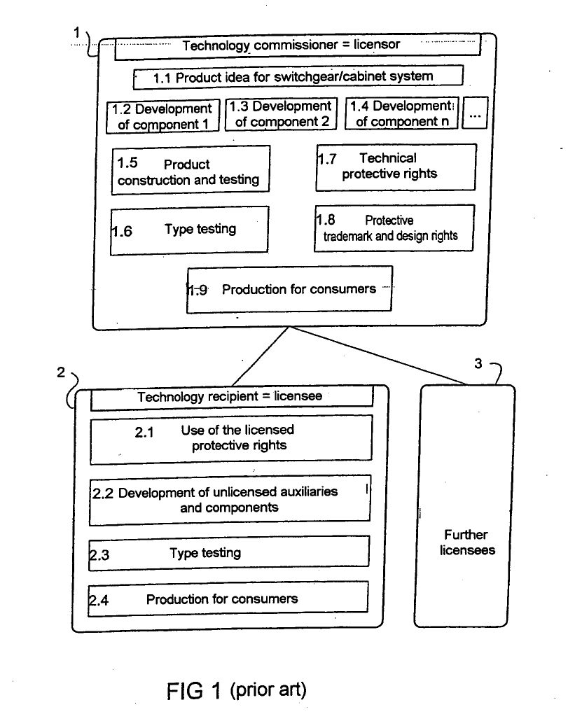

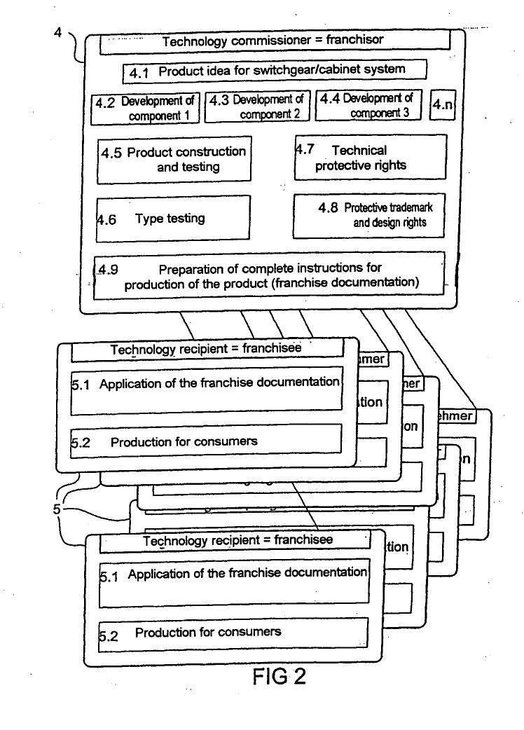

In the case of the method according to an embodiment of the invention, as it is illustrated in FIG. 2, the steps 4.1, 4.2, 4.3, 4.5, 4.6, 4.7 and 4.8 correspond analogously to 1.1 to 1.8 in FIG. 1. A significant difference is represented by step 4.9. In this step, following the development of the product and its type testing, the technology commissioner now acting as the franchisor 4 prepares as part of franchise documentation complete instructions for producing the product. This is done in such a way that these can be used for producing products with the same characteristics and the same properties as the products of the technology commissioner. This relieves the technology recipient acting as the franchisee (blocks 5 in FIG. 2) of the requirement to carry out separate type testing.

For the franchisee, this brings with it the decisive advantage that it is able to deliver in a significantly shorter time than would be the case under a customary license contract corresponding to FIG. 1. Application of the franchise documentation in step 5.1 directly yields type-tested products, which it produces for its consumers in step 5.2.

FIG. 2 illustrates that the franchisor 4 can be linked up with a greater number of franchisees (blocks 5), the commercial size of which may vary. The franchisor 4 can adapt its franchise documentation (4.9) to this, in that for example it provides that certain components are supplied by it as and when required or that certain semifinished products or raw materials are supplied from stipulated supply sources.

Although it has been pointed out that steps 4.1 to 4.8 in FIG. 2 correspond to steps 1.1 to 1.8 in FIG. 1, it is possible for the content of steps 4.2, 4.3, 4.4 in particular, and possibly further corresponding steps, to be different to the extent that the development result that is aimed for takes into account from the outset the particular conditions that may pertain to franchisees. These include, for example, the size and facilities of the franchisee's plant. For example, depending on the production and assembly processes that the franchisees have at their disposal, a certain component of the product may therefore be developed as a multi-functional plastic injection molding or as a technically equivalent stamped and bent part. Consequently, the component concerned can be cost-effectively produced both by large operators and by smaller and medium-sized operators.

As already mentioned, low-voltage switchgear and cabinet systems are highly specialized products with corresponding requirements in terms of reliability, service life and technical security. To meet the resultant responsibility, the franchisor must make sure that products provided with its identification actually conform to the franchise documentation (4.9 in FIG. 2). This is achieved by an identifying device which the franchisor makes available to the franchisee and the latter attaches to the product before delivery to the consumer.

As a first simple example of such an identifying device 6, FIG. 3 shows a self-adhesive label with a data carrier 7 in the form of a barcode known for the identification of goods. This may be constructed for example in such a way that at least the names of the franchisor and the franchisee and also a designation of the product are included. If the identifying device 6 according to FIG. 3 is attached at a suitable point of the product, it is possible by way of a portable reader 8 likewise indicated in FIG. 3 (barcode scanner as at a point of sale) to display the data carrier 7 on a display device 9 of the reader 8.

Since the barcode can be duplicated without any problem, it is recommendable to attach the identifying device 6 provided with it at a point of the product known only to the authorized inspector of the franchisor and the franchisee. The identifying device 6 may also be attached to a component of the product supplied by the franchisor, in such a way that only the franchisor's authorized inspector can find the identifying device 6.

While the identifying device 6 according to FIG. 3 is a passive identifying device, active, i.e. writable and readable, identifying device may also be used, involving a series of advantages.

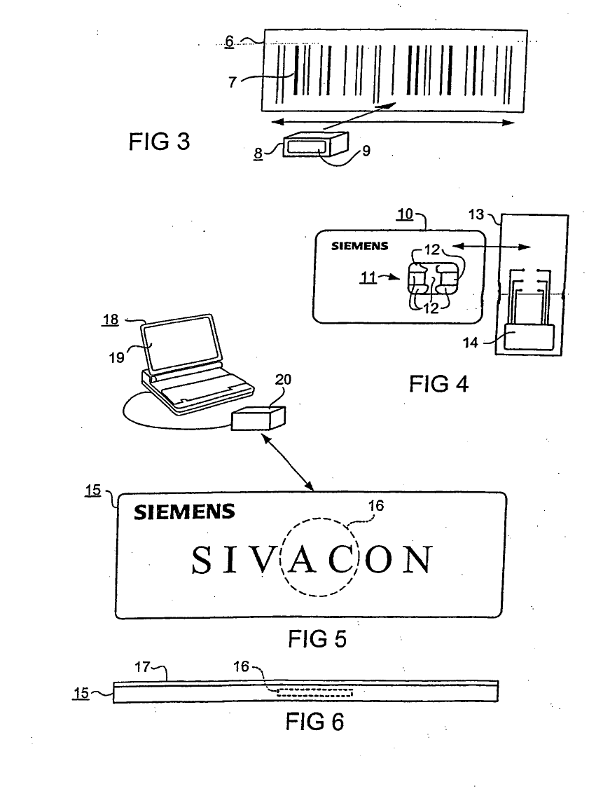

As an example of an active identifying device 10, FIG. 4 shows a chip card or smart card. The identifying device 10, which is consequently similar to a bank card or insurance card, accordingly bears as a data carrier 11 an integrated chip with contact areas 12, which can be contacted by way of a suitable reader 13 in order to view the data content and make it visible by way of a display device 14 (LCD or similar). The data content may be significantly more extensive than a barcode corresponding to FIG. 3. In particular, it is therefore possible to store in the identifying means 10 not just the general type of product but specific information concerning the individual product, such as an order date, circuit diagram, device provided and the like.

To fully exploit the extent of data that can be stored, as made possible by an identifying device 10 according to FIG. 4, it may be provided within the framework of the franchise agreement that the franchisee transmits to the franchisor information specific to a respective order and the franchisor transfers to the franchisee an identifying device 10 provided with the corresponding data for attachment to the finished product. In the case of banking and other cards including insurance cards, the identifying device 10 may also contain the data in a cryptographically secured form. An authorized inspector of the franchisor is therefore capable with the aid of his reader 13 of reading the data contained in the data carrier 11. In addition, the point in time and further aspects of an inspection of the identifying device 10 may be registered in the latter (i.e. in the data carrier 11).

As a particularly versatile identifying device 15, FIG. 5 shows a designation plate, which contains a transponder unit as a data carrier 16. The identifying device 15 can be visibly attached to the product by way of a self-adhesive layer 17, indicated in FIG. 6, and presents the viewer for example with the name of the franchiser and a product name. The data carrier 16 is completely embedded in the material of the designation plate 15 in such a way that it is invisible to the viewer. In a way similar to that known in the case of securing goods in department stores and other retail outlets, a reader 18 can make contact with the identifying device 15 or the data carrier 16.

As a difference from the customary securing of goods, in which the only concern is to detect the removal of an item from an area under surveillance, the reader 18 is formed as a portable unit which is able, by way of a display device 19, to present the data content of the data carrier 16. The latter may be made similar in extent and content to that in the case of the data carrier 11 according to FIG. 4. The contactless communication between the reader 18 and the identifying device 15 makes the inspection of a relevant product particularly easy.

In FIG. 5, the portable reader is illustrated as a notebook PC or handheld PC, which is connected to a transmitting and receiving adapter 20 for communication.

Examples of how products of the type considered in the present case are provided with an identifying device according to an embodiment of the invention are explained below on the basis of FIGS. 7, 8 and 9.

A switch cabinet 21 shown in FIG. 7 is represented with the door closed 22. In a known way, the door 22 does not extend over the entire height of the switch cabinet 21, but leaves a bottom panel 23 and a top panel 24 free. Not only the door 22 but also the bottom panel 23 and the top panel 24 come into consideration for the attachment of an identifying device 6, 10 or 15.

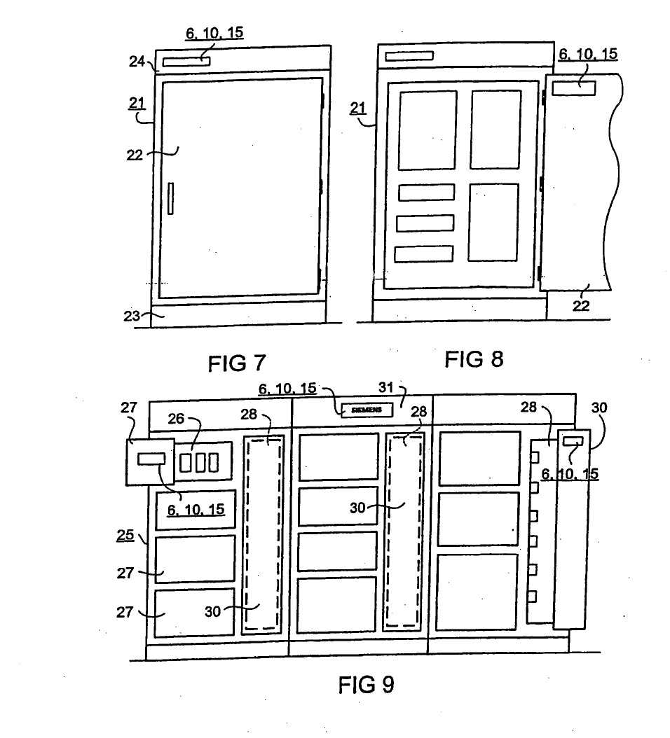

The same identifying device 6, 10 or 15 can also be used in principle in such a way that they are accessible when the switch cabinet 21 is open. For this purpose, FIG. 8 shows the switch cabinet 21 with the door 21 open, an identifying device 6, 10 or 15 having been attached to the inner side of the door 22. 10 is better suited for this than for external attachment, because impairment of the contact areas 12 of the data carrier 11 is not to be feared.

Appropriate possibilities for the attachment of identifying device 6, 10 or 15 are suitable if the product is a low-voltage switchgear unit 25, an example of which with three sections is schematically represented in FIG. 9. In the example shown, each section has device compartments 26 with their own doors 27 and also a common cable terminal compartment 28, which can likewise be closed by a door 30. An identifying device 6, 10 or 15 has been attached in the region of a top panel 31 of the middle section of the switchgear unit 25.

The identifying device 15 is particularly suitable here. Likewise suited for the attachment of the identifying device is the inner side of the door 30 of the cable terminal compartment 28 of each of the sections shown. Furthermore, the outer or inner surfaces of the doors 27 of the device compartments 26 are suitable for attachment of the identifying device.

Exemplary embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A method for producing a deliverable product for a consumer, in which a technology commissioner prepares a technical specification of the product and entrusts it to a technology recipient within the framework of a contractual agreement for delivery to the consumer, comprising:
providing the specification and further auxiliaries used for production of a product in a configuration, such that the technology commissioner acts as a franchisor, in the form of technical instructions and information, wherein
a recipient is able to act as a franchisee and exploit the specification and the auxiliaries; and
providing an identifying device including a data carrier, for the identification of the franchisor, wherein the identifying device is attachable to the product after production and prior to delivery of the product to a consumer.

2. The method as claimed in claim 1, wherein the data carrier includes a barcode.

3. The method as claimed in claim 1, wherein the identifying device includes, as a data carrier, an electronically evaluatable information storage device.

4. The method as claimed in claim 3, wherein the identifying device includes a card, which includes an integrated semiconductor chip as a data carrier.

5. The method as claimed in claim 2, wherein the data carrier includes a transponder unit.

6. The method as claimed in claim 1, wherein, before delivering a product to a consumer, the franchisor is able to receive, transmitted from the franchise, data of the product specific to an order of the consumer, the franchisor preparing an identifying device containing the specific data and transfer ring the identifying device to the franchisee, wherein the franchisee is able to attach the identifying device to the product before it is delivered.

7. The method as claimed in claim 1, wherein the identifying device is attachable to the front side of at least one of a switch cabinet and a switchgear unit.

8. The method as claimed in claim 1, wherein the identifying device is fixable inside at least one of a switch cabinet and a switchgear unit.

9. The method as claimed in claim 1, wherein the identifying device is fixable in such a way that it cannot be detached.

10. An identifying device for use in the method as claimed in claim 1, wherein the identifying device is formed as a designation plate provided with a logo designating the franchisor and including the data carrier.

11. The identifying device as claimed in claim 10, wherein the data carrier is embedded in the material of the identifying device formed as a designation plate.

12. The identifying device as claimed in claim 11, wherein the data carrier is enclosed by the material of the identifying device and invisible.

13. The method of claim 1, wherein the method is for delivering a product to a consumer in the field of electrotechnical switchgear and cabinet systems.

14. The method of claim 1, wherein the specification and further auxiliaries are provided in a type-tested configuration in the form of technical instructions and information.

15. The method of claim 1, wherein rights to use a trademark of the technology commissioner are also provided to the franchisee, wherein the franchisee is able to also exploit the rights to use the trademark of the technology commissioner.

16. The method of claim 1, wherein the data carrier is for the identification of the franchisor and is readable by electronic reader.

17. The method of claim 2, wherein a portable barcode reader is provided, operatable independently of the power supply system and including a display device, for registering the data content of the barcode.

18. The method of claim 4, wherein a portable reader is provided, operatable independently of the power supply system and including a display device, for registering the data of the data carrier.

19. The method as claimed in claim 5, wherein a portable reader with an independent energy supply and a display device is provided for registering the data content of the data carrier.

20. The method as claimed in claim 1, wherein the identifying device is fixable in such a way that it can only be detached in such a way that at least one of damage and destruction ensues.

21. A method, comprising:
providing a specification and auxiliaries used for production of a product in a configuration, by a franchisor, in the form of technical instructions and information, wherein a recipient is able to act as a franchisee and exploit the specification and the auxiliaries; and
providing an identifying device, including a data carrier, for the identification of the franchisor, wherein the identifying device is attachable to the product after production and prior to delivery of the product to a consumer.

22. The method as claimed in claim 21, wherein the data carrier includes a barcode.

23. The method as claimed in claim 21, wherein the identifying device includes, as a data carrier, an electronically evaluatable information storage device.

24. The method as claimed in claim 23, wherein the identifying device includes a card, which includes an integrated semiconductor chip as a data carrier.

25. The method as claimed in claim 22, wherein the data carrier includes a transponder unit.

26. The method as claimed in claim 21, wherein, before delivering a product to a consumer, the franchisor is able to receive, transmitted from the franchisee, data of the product specific to an order of the consumer, the franchisor preparing an identifying device containing the specific data and transferring the identifying device to the franchisee, wherein the franchisee is able to attach the identifying device to the product before it is delivered.

27. The method as claimed in claim 21, wherein the identifying device is attachable to the front side of at least one of a switch cabinet and a switchgear unit.

28. The method as claimed in claim 21, wherein the identifying device is fixable inside at least one of a switch cabinet and a switchgear unit.

29. The method as claimed in claim 21, wherein the identifying device is fixable in such a way that it cannot be detached.

30. An identifying device for use in the method as claimed in claim 21, wherein the identifying device is formed as a designation plate provided with a logo designating the franchiser and including the data carrier.

31. The identifying device as claimed in claim 30, wherein the data carrier is embedded in the material of the identifying device formed as a designation plate.

32. The identifying device as claimed in claim 31, wherein the data carrier is enclosed by the material of the identifying device and invisible.

33. The method of claim 31, wherein the method is for delivering a product to a consumer in the field of electrotechnical switchgear and cabinet systems.
